(19) United States
(12) Patent Application Publication
(10) Pub. No.: US 2016/0169438 A1
(43) Pub. Date: Jun. 16, 2016

(54) INSULATION SYSTEM

(71) Applicant: Harrill Ashley CHALLENOR, City Beach, Western Australia (AU)

(72) Inventor: Harrill Ashley CHALLENOR, City Beach (AU)

(21) Appl. No.: 14/907,337

(22) PCT Filed: Jul. 28, 2014
(86) PCT No.: PCT/AU2014/000762

§ 371 Date: Jan. 25, 2016

(30) Foreign Application Priority Data
Jul. 26, 2013 (AU) 2013902778

(51) Int. Cl. F16L 59/14; F16L 59/02

(52) U.S. Cl. CPC F16L 59/14; F16L 59/029

(57) ABSTRACT

An insulation system comprising low density foam with a tensile modulus less than 5 MPa at ambient conditions and less than 10 MPa under cryogenic service conditions.

### TECHNICAL FIELD

The present invention relates to an insulation system. More particularly, the insulation system of the present invention is adapted to clad and insulate fluid transport and storage systems.

### BACKGROUND ART

The following discussion of the background art is intended to facilitate an understanding of the present invention only. The discussion is not an acknowledgement or admission that any of the material referred to is or was part of the common general knowledge as at the priority date of the application.

Insulation cladding for pipes operating at low temperatures typically uses low density polyurethane/polyisocyanurate foam and or cellular glass sections. Typical applications for such pipe cladding are where the process pipework is required to operate at temperatures below 100° C. High quality insulation systems currently being used in deep cryogenic service to −200° C. consist of layers of prefabricated sections that are assembled piecemeal onto the pipe in a sequential manner, layer by layer or of layers of spray or pour applied insulation. High quality insulation systems installed in these manners require contraction joints between fixed points in the pipework system. The installation process requires highly skilled labour, is time consuming, wasteful of materials and access to the pipe is often limited and the time taken to complete the installation is lengthy.

Installation of cold insulation is invariably one of the last major tasks to be completed on industrial projects and is a critical path activity. Time saved in the installation of the cold insulation is time saved on the duration of the whole project. Skilled insulation installers are difficult to find for most remote projects and reducing the skills requirement will assist in completing the insulation work earlier.

Traditional cold insulation materials of cellular glass and/or low density polyurethane/polyisocyanurate are not able to withstand the thermal gradient from cryogenic temperature on the cold face to the ambient temperature on the hot face in one layer without cracking in service. Cracks that penetrate from the inner surface to the outer surface provide a heat in-leak path that can cause the insulation system to fail.

Throughout the specification, unless the context requires otherwise, the word “comprise” or variations such as “comprises” or “comprising”, will be understood to imply the inclusion of a stated integer or group of integers.

### SUMMARY OF INVENTION

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in the specification, individually or collectively and any and all combinations or any two or more of the steps or features.

The present invention is not to be limited in scope by the specific embodiments described herein, which are intended for the purpose of exemplification only. Functional equivalent products, compositions and methods are clearly within the scope of the invention as described herein.

The entire disclosures of all publications (including patents, patent applications, journal articles, laboratory manuals, books, or other documents) cited herein are hereby incorporated by reference.

In accordance with the present invention, there is provided an insulation system comprising low density foam with a tensile modulus less than 5 MPa at ambient conditions and less than 10 MPa under cryogenic service conditions.

Preferably, the tensile modulus of the low density foam is less than 3 MPa at ambient conditions and less than 6 MPa under cryogenic service conditions.

In one form of the invention, the tensile modulus of the low density foam is about 3 MPa at ambient conditions and about 6 MPa under cryogenic service conditions.

In a specific form of the invention, the low density foam is provided in the form of CETRAFOAM® from Cetra Technologies Pty Ltd.

CETRAFOAM® is moulded using an ultra high overpack method that provides consistency in microcell size and shape throughout the product. This provides uniform density and identical mechanical and thermal properties both parallel and perpendicular to the direction of rise. The moulded product has a tough external high density skin which significantly reduces site wastage from transport and installation damage.

CETRAFOAM® is specially formulated for cryogenic insulation applications from +140° C. to −200° C. The PUR/PIR formulation provides excellent fire resistance and a high tensile modulus which ensures a high Cryogenic Thermal Stress Resistance Factor (CTSR≧2). This allows CETRAFOAM® to be applied in a single layer up to thicknesses of 250 mm.

CETRAFOAM® has a Tensile Modulus of 2.98 MPa at 22° C. and 5.87 at −165° C. and can withstand the thermal shrinkage stresses associated with insulating across a thermal gradient of up to 200° C.

Technical data related to CETRAFOAM® are provided in Table 1.

TABLE 1
CETRAFOAM ® Technical Data

| Property | Unit | Test Method | Value |
|---|---|---|---|
| Density | Kg/m³ | ASTM D 1622 | ≧45 |
| Closed Cell Content | % | ASTM D 2856 | ≧90 |
| Water Vapour Permeance | μg/Ns | ASTM E 96 | ≦4.5 |
| 30° C. and 100% RH | | | |
| Fire Properties | | | |
| Maximum mean extent of burn | mm | BS 4735 | 26 |
| Maximum mean extinguishing | secs | BS 4735 | ≦5 |
| time | | | |
| Maximum mean burning rate | mm/sec | BS 4735 | 0.41 |
| Oxygen Index | % | GB8624-1997 | ≧26 |
| Coefficient Thermal Expansion | mm/ | ASTM D 696 | 50-70 |
| | mmK × | | |
| | 10⁻⁶ | | |
| Compressive Strength | kPa | ASTM D 1621 | ≧250 |
| @ 20° C. | | | |
| Compressive Strength | kPa | ASTM D 1621 | ≧650 |
| @ −165° C. | | | |
| Tensile Strength @ 20° C. | kPa | ASTM D 1623 | ≧510 |
| Tensile Modulus @ 20° C. | MPa | ASTM D 1623 | 2.98 |
| Tensile Strength @ −165° C. | kPa | ASTM D 1623 | ≧380 |
| Tensile Modulus @ −165° C. | MPa | ASTM D 1623 | 5.86 |
| Leachable Halides | ppm | ASTM C 871 | ≦15 |
| Thermal Conductivity @ 20° C. | | | |
| Fresh Blown foam | W/m° K | ASTM C 177 | 0.022 +/− |
| Aged at 21° C. for 180 days | | | 0.001 |
| | | | 0.025 +/− |
| | | | 0.001 |
| Cryogenic Thermal Stress | | | ≧2 |
| Resistance | | | |

It will be appreciated that the tensile modulus of the low density foam affects the tensile strength and that it is necessary to maintain a certain level of tensile strength. Preferably, the low density foam has a compressive strength above 200 kPa under ambient conditions and 500 kPa at cryogenic service temperature. More preferably, the low density foam has a compressive strength above 250 kPa under ambient conditions and 600 kPa at cryogenic service temperature.

Advantageously, reducing the tensile modulus whilst maintaining the tensile strength of the low density foam reduces the brittleness at cryogenic temperature. This enables the foam to better withstand shrinkage strain imposed on the cold face of the foam in cryogenic service.

Preferably, the low density foam has a compressive modulus compressive modulus at ambient temperature which can accommodate the longitudinal thermal shrinkage of the pipe without exceeding the maximum strain in the foam and also have sufficient compressive strength to withstand site applied loads such as foot traffic.

Preferably, the low density foam has a compressive modulus less than 16 MPa under cryogenic service conditions.

Advantageously, only one layer of the insulation system may be required to achieve desired results.

The insulation system of the present invention is adapted to insulate fluid storage and transfer systems comprising fluids at depressed, ambient and elevated temperatures.

The fluid storage and transfer systems may be provided in the forms of pipes, tanks, tankers, vessels and related equipment for the storage and transport of fluids such as liquid/gas hydrocarbons, liquid nitrogen, liquid hydrogen, liquid oxygen, liquid carbon dioxide and liquid ammonia.

Preferably the insulation system is provided in the form of complimentary sections adapted to cover at least a portion of the outer surface of the fluid storage and transfer system.

Where the fluid storage and transfer system is a pipe, the insulation system is preferably provided in the form of a plurality of complimentary cylindrical sections adapted to cover at least a portion of the outer surface of the pipe. In one embodiment of the invention, the insulation is provided in the form of two complimentary semi cylindrical sections adapted to cover at least a portion of the outer surface of the pipe.

Cylindrical sections may be longitudinally attached to further longitudinally adjacent cylindrical sections to increase the length of the insulation system and cover greater portions of the pipe.

Advantageously, the insulation system of the present invention reduces the work required to install insulation on industrial plants where the insulation installation is a major activity on the project critical path. This is particularly the case for cryogenic insulation. The on-site work content is reduced because the insulation does not have to be prepared at the site. Prior art insulation systems utilising cellular glass and low density foams must be constructed layer by layer at site. For cold and cryogenic applications the present invention may be applied in one single layer irrespective of the diameter of the pipe or the operating temperature of the pipe. The time and labour reduction at site will speed up the installation of the insulation and allow projects to be completed earlier. The installation cost savings and the potential additional earnings available through bringing the project online earlier are significant when compared with the cost of the insulation.

The insulation system may further comprise an inner layer of resilient fibre glass blanket or cryogel blanket or solimide foam insulation material

The insulation system may further comprise a vapour barrier layer.

The insulation system may further comprise mechanical protection cladding.

In one form of the invention, the low density foam comprises reinforcing. The reinforcing may be provided in the form of fibreglass mesh. Preferably, the reinforcing resides within the low density foam and close to both its inner and outer surfaces. Preferably the reinforcing is embedded within the low density foam during preparation of the low density foam layer. The reinforcing serves to strengthen the low density foam to better resist damage from external loads imposed on the insulation system such as foot traffic on horizontal pipework.

In one form of the invention, the reinforcing mesh embedded in the low density foam has its fibres aligned in a square mesh with the fibres 90 degrees to each other with one set of fibres running longitudinally to the low density foam moulding and the other set of fibres transversely located. In this configuration, the fibreglass reinforcing mesh reduces the modulus of expansion and contraction of the low density foam to approximately that of stainless steel over the range of temperatures from −200 degrees Celsius to plus 100 degrees Celsius, namely between 15 to 20×10⁻⁶ mm/mm/degree Kelvin which is substantially reduced from the unreinforced low density insulation foam coefficient of thermal expansion and contraction which is between 50 to 70×10⁻⁶ mm/mm/degree Kelvin over the temperature range of −200 degrees Celsius to plus 100 degrees Celsius.

Advantageously, the reinforcing reduces the effective coefficient of thermal contraction of the foam reinforcement which limits the size of the gaps between adjoining pipe sections at the cold face. The reinforcement also makes the foam tougher and better able to resist transport and handling damage.

Preferably, the low density foam is a substantially closed-cell foam comprising a low-conductivity gas in the cells. In the context of the present invention, the term substantially closed cell foam shall be understood to indicate >90% closed-cell foam.

Advantageously, the low density foam has a relatively high resistance to heat flow compared to other types of insulation. It will be appreciated that many variables affect the final resistance to heat flow of foam insulation including the initial density of the foam, the blowing gas used (for example, CFC, HCFC, HFC, CO₂, air, hydrocarbon, or a number of other gases or combinations thereof) and how the foam is handled (dents and chips adversely affecting the resistance to heat flow). The skilled addressee will appreciate that different applications may require foams with difference resistance to heat flow. It will further be appreciated that the resistance to heat flow of the foam will have a bearing on the thickness of the foam layer in the insulation system.

In one form of the invention, the insulation system further comprises a vapour barrier.

In a specific form of the invention, the moulded low density foam may be installed on pipework between two fixed points without an expansion and contraction joint.

Preferably, the circumferential ends of the low density insulation foam are provided with joints adapted to reduce heat transfer between adjacent insulation systems. In a specific form of the invention, the joints are shiplap joints, complimentary with shiplap joints on adjacent insulation systems.

In a specific form of the invention the butt or shiplapped joints between adjacent sections are sealed with an adhesive sealant comprising a solvent free, high strength, thermosetting two component urethane adhesive.

Preferably, each longitudinal end of the low density insulation foam is provided with joints adapted to reduce heat transfer between the two longitudinal ends. In a specific form of the invention, the joints are shiplap joints, the shiplap joint on one longitudinal ends being complimentary with the shiplap joint on an opposed longitudinal end. In use, the shiplap joints engage to prevent through gaps and reduce heat transfer.

Where provided, the shiplap joints may be sealed externally by either self-adhesive vapour barrier tape or by reinforced vapour barrier mastic.

In one form of the invention, the straight lengths of pipe insulation are confined axially on the pipe between moulded insulation elements which have been bonded to the pipe. In a specific form of the invention the bonded moulded elements will be adjacent to pipe supports or pipe fittings such as elbows, Tees, flanges, valves, reducers and other fixed elements attached to the pipe.

In accordance with a second aspect of the present invention, there is provided a method for insulating fluid storage and transfer systems comprising the steps of applying a single layer pre-formed low density insulation foam to the fluid storage and transfer system, wherein the low density foam has a tensile modulus less than 5 Mpa at ambient conditions and less than 10 Mpa under cryogenic service conditions.

Preferably, the tensile modulus of the low density foam is less than 3 MPa at ambient conditions and less than 6 MPa under cryogenic service conditions.

In one form of the invention, the tensile modulus of the low density foam is about 3 MPa at ambient conditions and about 6 MPa under cryogenic service conditions.

In a specific form of the invention, the low density foam is provided in the form of CETRAFOAM® from Cetra Technologies Pty Ltd.

Preferably, the low density foam has a compressive strength above 200 kPa under ambient conditions and 500 kPa at cryogenic service temperature. More preferably, the low density foam has a compressive strength above 250 kPa under ambient conditions and 600 kPa at cryogenic service temperature.

Preferably, the low density foam has a compressive modulus less than 16 MPa under cryogenic service conditions.

Advantageously, only one layer of the insulation system may be required to achieve desired results.

The fluid storage and transfer systems may be provided in the forms of pipes, tanks, tankers, vessels and related equipment for the storage and transport of fluids such as liquid/gas hydrocarbons, liquid nitrogen, liquid hydrogen, liquid oxygen, liquid carbon dioxide and liquid ammonia.

Preferably the insulation system is provided in the form of complimentary sections adapted to cover at least a portion of the outer surface of the fluid storage and transfer system.

Where the fluid storage and transfer system is a pipe, the insulation system is preferably provided in the form of a plurality of complimentary cylindrical sections adapted to cover at least a portion of the outer surface of the pipe. In one embodiment of the invention, the insulation is provided in the form of two complimentary semi cylindrical sections adapted to cover at least a portion of the outer surface of the pipe.

Cylindrical sections may be longitudinally attached to further longitudinally adjacent cylindrical sections to increase the length of the insulation system and cover greater portions of the pipe.

Advantageously, the insulation system of the present invention reduces the work required to install insulation on industrial plants where the insulation installation is a major activity on the project critical path. This is particularly the case for cryogenic insulation. The on-site work content is reduced because the insulation does not have to be prepared at the site. Prior art insulation systems utilising cellular glass and low density foams must be constructed layer by layer at site. For cold and cryogenic applications the present invention may be applied in one single layer irrespective of the diameter of the pipe or the operating temperature of the pipe. The time and labour reduction at site will speed up the installation of the insulation and allow projects to be completed earlier. The installation cost savings and the potential additional earnings available through bringing the project online earlier are significant when compared with the cost of the insulation.

The method of the present invention may further comprise the step of applying an inner layer of resilient fibre glass blanket or cryogel blanket or solimide foam insulation material

The method of the present invention may further comprise the step of applying a vapour barrier layer.

The method of the present invention may further comprise the step of applying mechanical protection cladding.

In one form of the invention, the low density foam comprises reinforcing. The reinforcing may be provided in the form of fibreglass mesh. Preferably, the reinforcing resides within the low density foam and close to both its inner and outer surfaces. Preferably the reinforcing is embedded within the low density foam during preparation of the low density foam layer. The reinforcing serves to strengthen the low density foam to better resist damage from external loads imposed on the insulation system such as foot traffic on horizontal pipework.

In one form of the invention, the reinforcing mesh embedded in the low density foam has its fibres aligned in a square mesh with the fibres 90 degrees to each other with one set of fibres running longitudinally to the low density foam moulding and the other set of fibres transversely located. In this configuration, the fibreglass reinforcing mesh reduces the modulus of expansion and contraction of the low density foam to approximately that of stainless steel over the range of temperatures from −200 degrees Celsius to plus 100 degrees Celsius, namely between 15 to 20×10⁻⁶ mm/mm/degree Kelvin which is substantially reduced from the unreinforced low density insulation foam coefficient of thermal expansion and contraction which is between 50 to 70×10⁻⁶ mm/mm/degree Kelvin over the temperature range of −200 degrees Celsius to plus 100 degrees Celsius.

Advantageously, the reinforcing reduces the effective coefficient of thermal contraction of the foam reinforcement which limits the size of the gaps between adjoining pipe sections at the cold face. The reinforcement also makes the foam tougher and better able to resist transport and handling damage.

Preferably, the low density foam is a substantially closed-cell foam comprising a low-conductivity gas in the cells. In the context of the present invention, the term substantially closed cell foam shall be understood to indicate >90% closed-cell foam.

Advantageously, the low density foam has a relatively high resistance to heat flow compared to other types of insulation. It will be appreciated that many variables affect the final resistance to heat flow of foam insulation including the initial density of the foam, the blowing gas used (for example, CFC, HCFC, HFC, CO₂, air, hydrocarbon, or a number of other gases or combinations thereof) and how the foam is handled (dents and chips adversely affecting the resistance to heat flow). The skilled addressee will appreciate that different applications may require foams with difference resistance to heat flow. It will further be appreciated that the resistance to heat flow of the foam will have a bearing on the thickness of the foam layer in the insulation system.

The method of the present invention may further comprise the step of applying a vapour barrier.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a perspective view of an insulation system in accordance with a first embodiment of the present invention;

FIG. 2 is a partial perspective view of the insulation system of FIG. 1;

FIG. 3 is a longitudinal cross-sectional view of the insulation system of FIG. 1;

FIG. 4 is an exploded perspective view of the insulation system of FIG. 1;

FIG. 5 is a longitudinal cross-sectional view of the insulation system of FIG. 1;

FIG. 6 is a partial longitudinal cross-sectional view of the insulation system of FIG. 1;

FIG. 7 is a partial longitudinal cross-sectional view of the insulation system of FIG. 1;

FIG. 8 is a radial cross-sectional view of the insulation system of FIG. 1;

FIG. 9 is an exploded perspective view of an insulation system in accordance with a second embodiment of the present invention; and

FIG. 10 is a perspective view of the insulation system of FIG. 10.

### DESCRIPTION OF EMBODIMENTS

The insulation system of the present invention will now be described, by way of example only, with reference to two embodiments thereof.

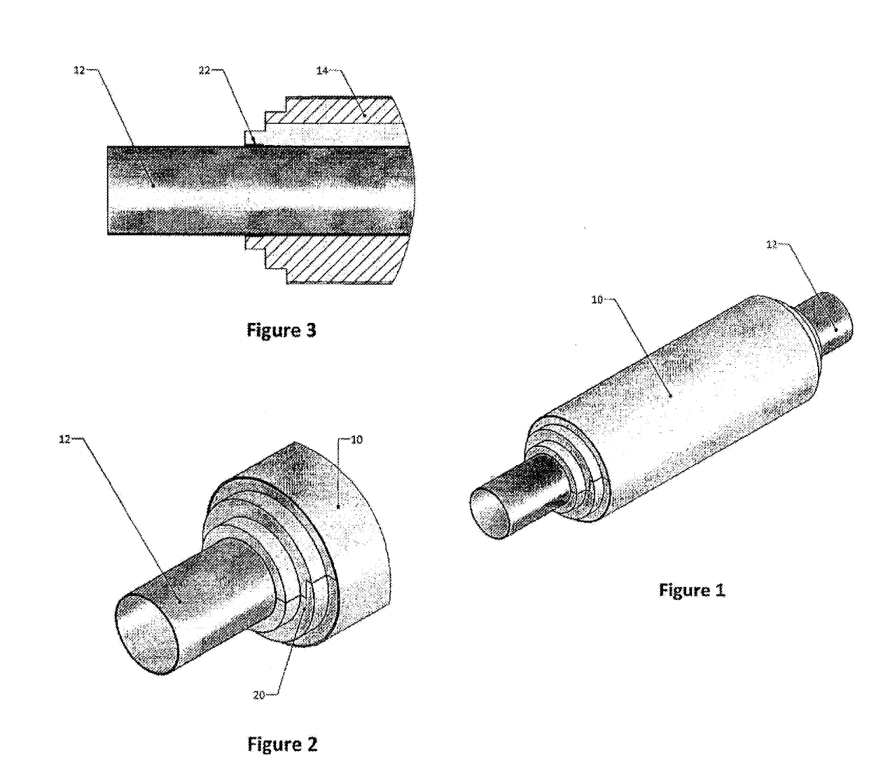

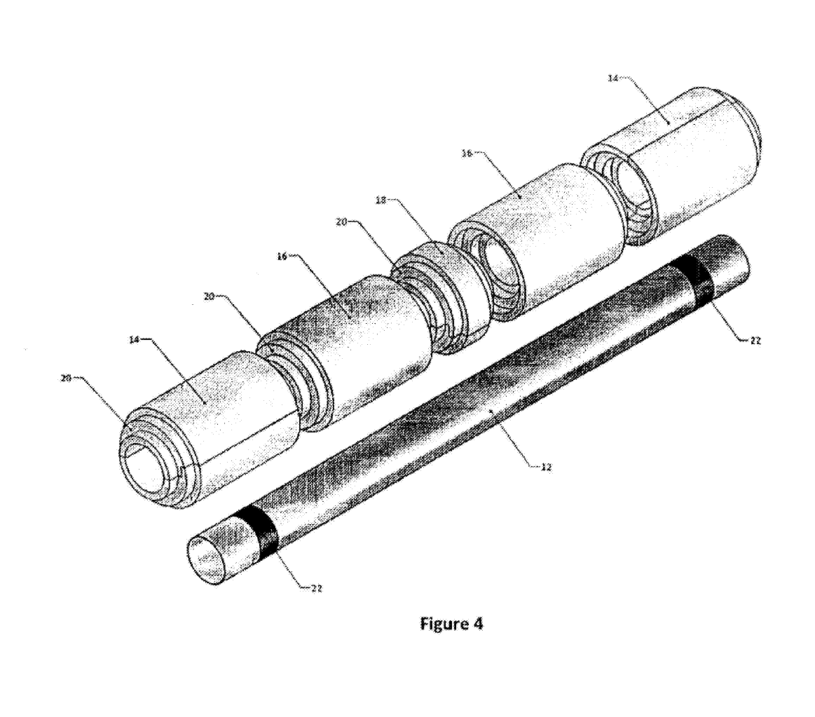

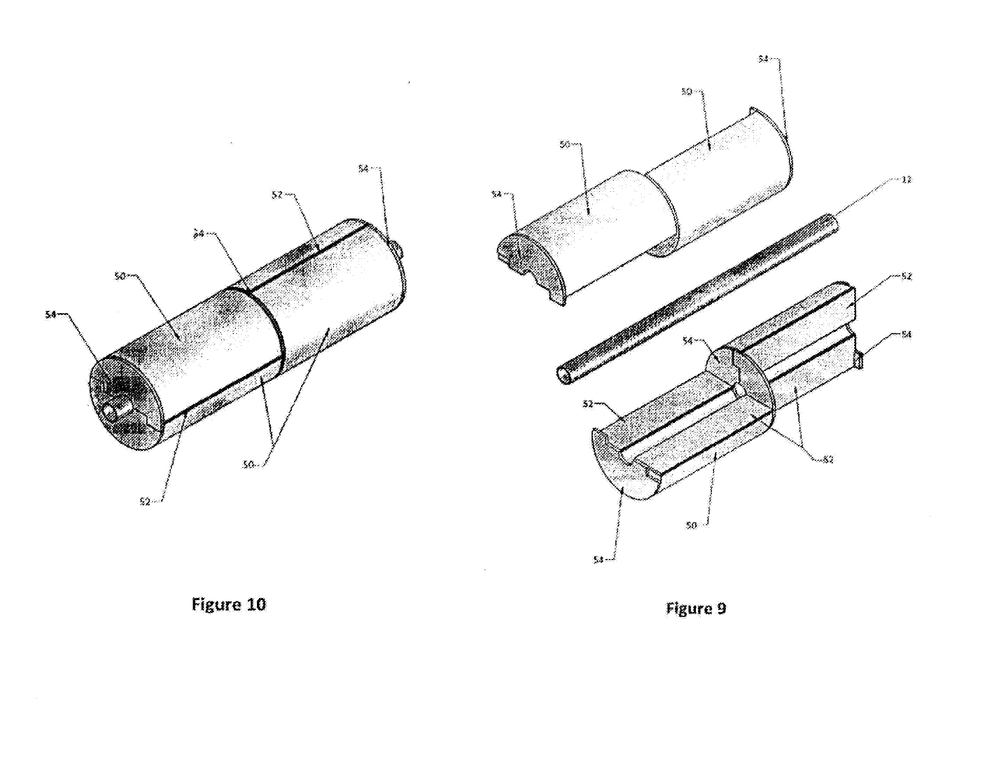

In FIGS. 1 through 9 there is shown an insulation system in accordance with a first embodiment of the present invention for insulation of fluid storage and transfer systems in the form of a prefabricated insulation system comprising a layer of preformed low density polyurethane foam 10. The preformed low density polyurethane foam 10 is provisded in the form of CETRAFOAM® from Cetra Technologies Ply Ltd. CETRAFOAM® is a 50 kg/m³ rigid, closed cell, HCFC free PUR/PIR foam. As seen in FIG. 1, the insulation system is cylindrical and is adapted to encase at least a portion of a pipe 12. As shown in FIG. 4, the insulation system comprises a number of complimentary moulded cylinders of varying lengths 14, 16 and 18.

Shiplap joints 20 are provided longitudinally and at each circumferential end of the moulded cylinders 14, 16 and 18 for mating with an adjacent cylinders, best seen in FIGS. 2, 3 and 4.

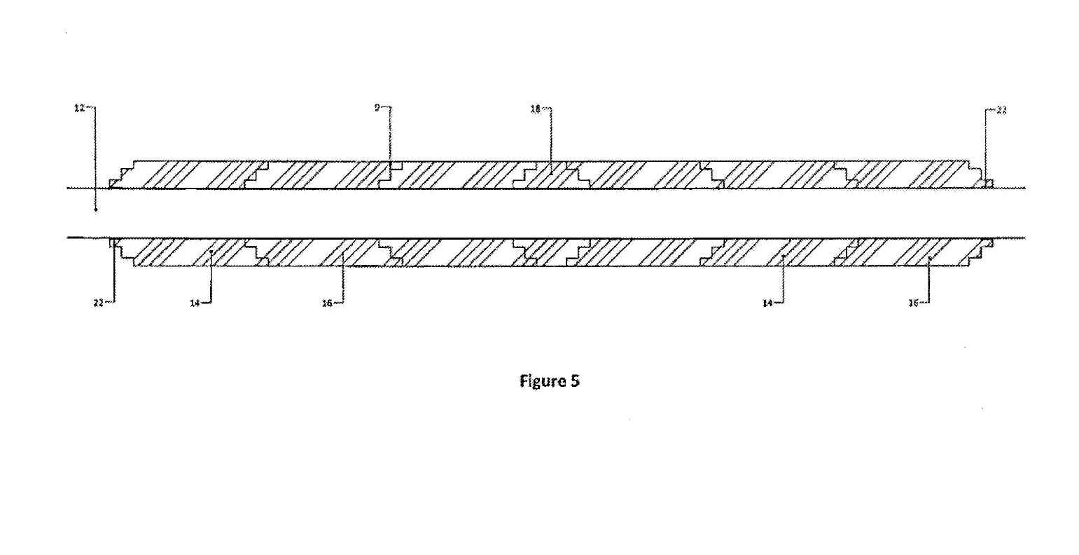

FIGS. 4 and 5 depict an arrangement with cylinders 14 and 16 placed over the pipe 12 and makeup section 18 introduced to complete the insulation length required. Cylinders 14 are bonded to the pipe 12 with cryogenic adhesive 22. If required, end cylinders 14 may be longitudinally cut into half sections to facilitate the application of the adhesive 22 between the pipe 12 and the moulded insulation 14.

A butyl rubber/aluminum vapour barrier 24 is provided on the outer surface of the insulation cylinders 14, 16 and 18. The outer vapour barrier 24 is protected from mechanical damage by a metallic or rigid epoxy cladding 26.

In one special application of the present invention the outer vapour barrier is provided by a fibre reinforced epoxy or polyester or acrylic covering.

The insulation system further comprises a cladding layer 28 moulded cylinder 14 with an elastomeric adhesive 30 which allows some minor radial contraction of the cylinder 14 whilst retaining the longitudinal location of the cladding 26.

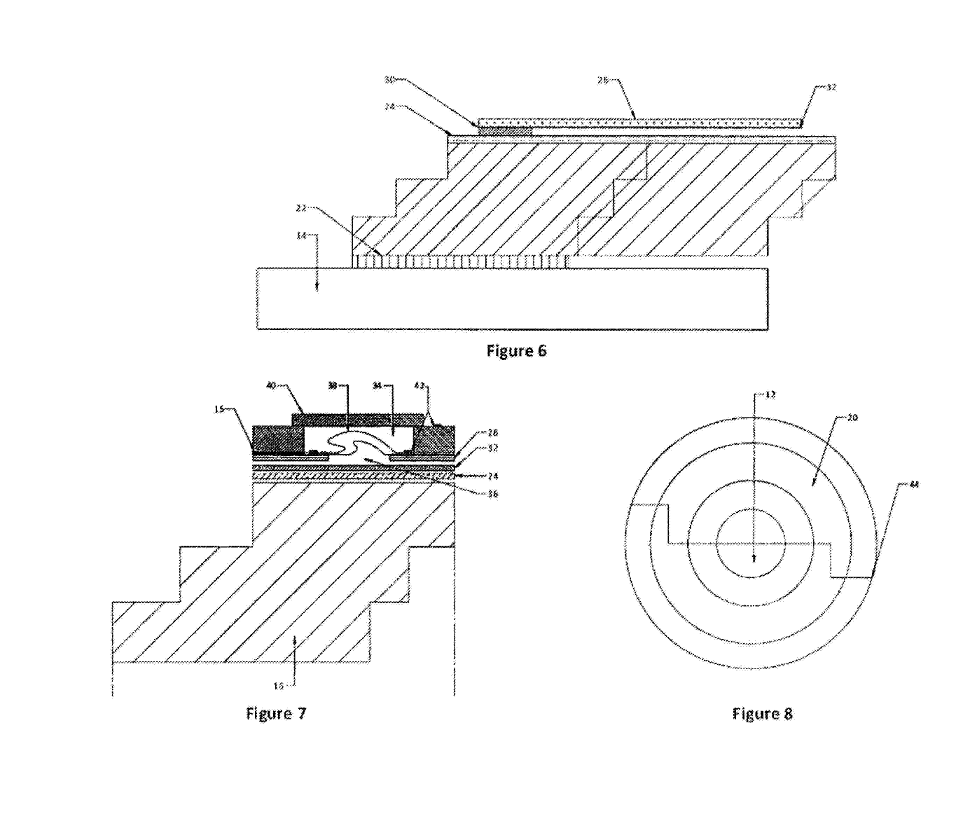

A slip layer 32 is provided between the vapour barrier 24 and the outer cladding 26 as shown in FIG. 6, 7. The slip layer facilitates dis-bondment between the outer cladding 26 which is at ambient temp and doesn't shrink and the outer vapour barrier which is adhered to the foam insulation sections which are compressed by the longitudinal thermal shrinkage of the pipe to which they are adhered and confined between the fixed point extremities of the pipe.

To allow for the axial contraction of the pipe, there is further provided a contraction/expansion joint 34 (see FIG. 7) to accommodate the differential thermal expansion/contraction of the pipe 12 operating at cryogenic service conditions and the outer cladding 26 which operated at ambient temperature.

The contraction/expansion joint 34 comprises the outer vapour barrier 24 over the moulded cylinder 16 and a slip layer 32 covering beneath an opening 36 in the outer cladding 26. The opening 36 in the cladding 26 is sealed with a butyl rubber sheet 38 banded to the cladding 26 either side of the contraction/expansion joint 34. Mechanical protection is provided by and outer cladding cover 40 which is adhered to the cladding 26 at point 15 in FIG. 7.

Longitudinal shiplap joints 44 are provided to ensure there is no straight through joints in the single layer insulation system as shown in FIG. 8.

In FIGS. 10 and 11, there is shown an insulation system in accordance with a second embodiment of the present invention. Like numerals in FIGS. 10 and 11 denote like parts in FIGS. 1 to 9.

As shown in FIG. 10, the moulded cylinder 14 is provided as two complimentary half-pipes 50. Complimentary half-pipes 50 are thermally sealed longitudinally 52 and circumferentially 54 with cryogenic insulation material such as solvent free, high strength, thermosetting two component urethane adhesive.

1. An insulation system comprising low density foam with a tensile modulus less than 5 MPa at ambient conditions and less than 10 MPa under cryogenic service conditions.

2. The insulation system in accordance with claim 1, wherein the tensile modulus of the low density foam is less than 3 MPa at ambient conditions and less than 6 MPa under cryogenic service conditions.

3. The insulation system in accordance with claim 1, wherein the tensile modulus of the low density foam is about 3 MPa at ambient conditions and about 6 MPa under cryogenic service conditions.

4. The insulation system in accordance with claim 1, wherein the low density foam has a compressive strength above 200 kPa under ambient conditions and 500 kPa at cryogenic service temperature.

5. The insulation system in accordance with claim 1, wherein the low density foam has a compressive strength above 250 kPa under ambient conditions and 600 kPa at cryogenic service temperature.

6. The insulation system in accordance with claim 1, wherein the low density foam has a compressive modulus less than 16 MPa under cryogenic service conditions.

7. The insulation system in accordance with claim 1, wherein the insulation system comprises a vapour barrier layer.

8. The insulation system in accordance with claim 1, wherein the insulation system comprises mechanical protection cladding.

9. The insulation system in accordance with claim 1, wherein the low density foam comprises reinforcing.

10. The insulation system in accordance with claim 9, wherein the reinforcing is fibreglass mesh.

11. The insulation system in accordance with claim 1, wherein the circumferential ends of the low density foam are provided with joints adapted to reduce heat transfer between adjacent insulation systems.

12. The insulation system in accordance with claim 1, wherein the longitudinal end of the low density foam is provided with joints adapted to reduce heat transfer between the two longitudinal ends.
